(19) United States
(12) Patent Application Publication
(10) Pub. No.: US 2004/0064325 A1
(43) Pub. Date: Apr. 1, 2004

(54) Intelligent use of encoder unused bandwidth in a digital audio broadcast

(76) Inventors: Majid Syed, Princeton, NJ (US); Deepen Sinha, (US)

Correspondence Address: Blaney Harper, Jones, Day, Reavis & Pogue, 51 Louisiana Ave., NW, Washington, DC, 20001-2113, US

(21) Appl. No.: 10/259,072

(22) Filed: Sep. 27, 2002

(51) Int. Cl. G10L 19/00

(52) U.S. Cl. 704/500

(57) ABSTRACT

Datacasting bandwidth enhancements are accomplished using a perceptual audio coder (PAC) that indicates, to a push-pull gateway (PPG), the availability of deterministic and opportunistic bandwidth. In case of real-time programs, data is pulled from a pre-managed datacasting service queue, and the deterministic bandwidth is used for real-time low bit-rate program related information and the opportunistic bandwidth is used for transmission of encoded non-real-time data content. For recorded content, further enhancement is achieved by preprocessing the audio song. The PAC identifies data rate (e.g., in kbps) and the deterministic and opportunistic deterministic bandwidth available (with delay variance). This information is conveyed to a push-pull gateway which performs management of data content destined for the deterministic opportunistic queue.

### RELATED APPLICATIONS

This application is related to commonly assigned and co-pending application entitled “System and Method Providing a Push Gateway Between Consumer Devices and Remote Content Provider Centers”.

### FIELD OF THE INVENTION

The present invention relates generally to the field of broadcasting. More specifically, the present invention is related to dynamic allocation of bandwidth in digital audio broadcasts.

### BACKGROUND OF THE INVENTION

FIG. 1 illustrates a prior art system in the field of broadcasting. In this example, data content providers 102 are able to send data to broadcaster 104 via network 106 such as a local area network (LAN), wide area network (WAN), or the Internet. The broadcaster 104 then encodes the received data content (via encoder 108) and transmits the encoded content (via transmitter 110) over broadcast network 112 (such as a in-band on-channel or IBOC network) to one or more data receivers 114.

The encoder 108 in the above-described prior art is usually initialized to encode at a particular frequency rate. For example, encoder 108 may preset to operate at one of the following frequency rates: 256 kbps, 128 kbps, 64 kbps, or 32 kbps. The higher the frequency rate (of encoding) associated with encoder 108, the higher the bandwidth required for transmitting the encoded data content. Thus, there is a trade-off between the encoding rate and bandwidth.

Preset encoding rates are efficient when the nature of the input signal is already known. But, in real life this is seldom the case, as the input to encoder 108 follows variable characteristics. Thus, if the input is a talk show, there are periods of silence wherein encoder 108 is inefficient, as it still encodes data at the preset frequency rate during these periods of silences, thereby consuming available bandwidth.

FIG. 2 illustrates an example of audio data associated with a talk show. The data comprises of one or more periods of activity (forming data blocks 1, 2, and 3) and one or more periods of inactivity (period 1 and period 2). If the rate of encoding associated with an encoder is set at a high rate (for example, 256 kbps), then precious time and bandwidth is wasted in encoding and transmitting audio data corresponding to the periods of inactivity.

### SUMMARY OF THE INVENTION

The present invention provides for a system and method for dynamically allocating bandwidth in a digital audio broadcast, wherein digital audio data is broadcast over a broadcast network such as an in-band on-channel (IBOC) network. In the preferred embodiment, a perceptual audio coder (PAC) indicates to a push-pull gateway (PPG) the availability of deterministic and opportunistic bandwidth. The PPG manages the content of both the deterministic queue and opportunistic queue. This management is done in advance or based on an indication of prior PAC bandwidth availability. For efficient IBOC bandwidth utilization, it is recommended that content (audio, talk) be pre-processed before transmitting over-the-air (This is for non-real-time over-the-air transmission). For example, preprocessing is performed on songs, and the available deterministic and opportunistic bandwidth are identified by the PAC. It is recommended that opportunistic bandwidth be used to transmit non-real-time services such as weather, traffic, and stocks, while the deterministic bandwidth be used for transmission of the encoded program-related data content such as artist name, title, etc. Similarly, if the program is a talk show, the deterministic bandwidth may carry dial-in number, host name, topic, etc.

### BRIEF DESCRIPTION OF THE DRAWINGS

FIG. 1 illustrates a prior art system in the field of broadcasting.

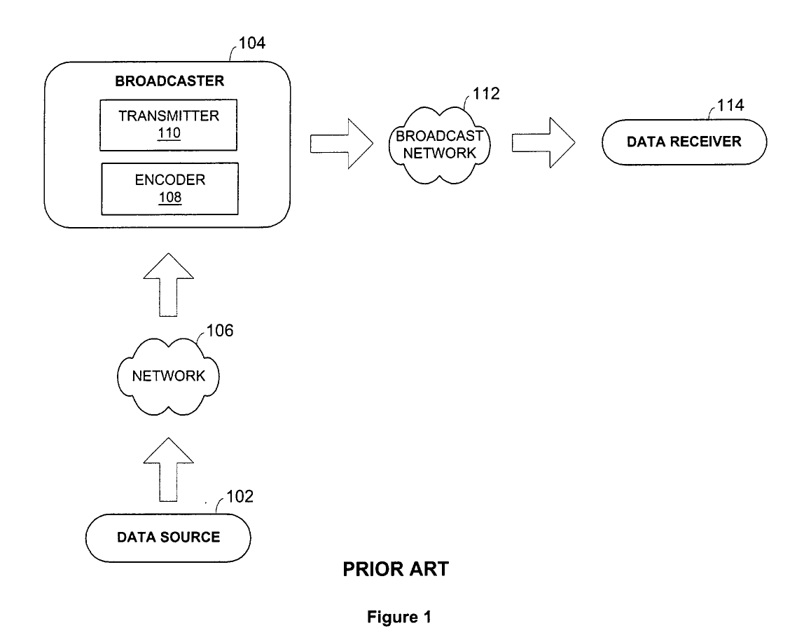

FIG. 2 illustrates an example of audio data associated with a talk show.

FIG. 3 illustrates datacasting bandwidth allotment by the system of the present invention when the input data is associated with real-time programs such as talk shows.

FIG. 4 illustrates datacasting bandwidth allotment by the system of the present invention when the input data is associated with one or more songs.

FIG. 5 illustrates a table summarizing transmission of various types of audio content in the deterministic and opportunistic bandwidths.

### DESCRIPTION OF THE PREFERRED EMBODIMENTS

The perceptual audio coder of the present invention provides for a system and method that solves the above mentioned shortcomings associated with the prior art and provides for a perceptual audio coder (PAC) that indicates deterministic and real-time opportunistic availability of bandwidth to a push-pull gateway.

Deterministic Bandwidth: The output of encoder is typically fixed (e.g., 32, 64, 96, 128 kbps). At startup, one encoder output is selected (for example, 96 kbps). Out of the assigned bitrate, part of the bandwidth is reserved for encoder house keeping functions and part of the bandwidth is kept for program related information. This allocation is called deterministic bandwidth. The left over bandwidth (which is again fixed) is reserved for content compression.

Opportunistic Bandwidth: The input to encoder may not be fixed, e.g., song, talk, or both. As talk may need only 32 or 64 kbps, the encoder fills 32 kbps with some other information. This left over bandwidth is called opportunistic bandwidth. Similarly, for noted and songs of different languages, not all 96 kbps is required. Instead the left over bandwidth is made available to the bandwidth manager.

To illustrate the functionality of the audio coder of the present invention, two instances of encoding are described in detail, wherein in the first instance the input data corresponds to a real-time program, and in the second instance the input data corresponds to one or more songs.

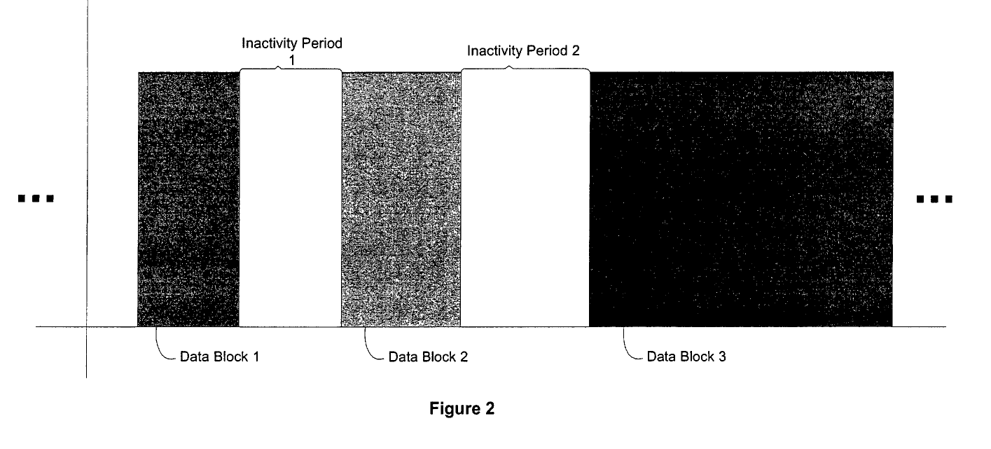

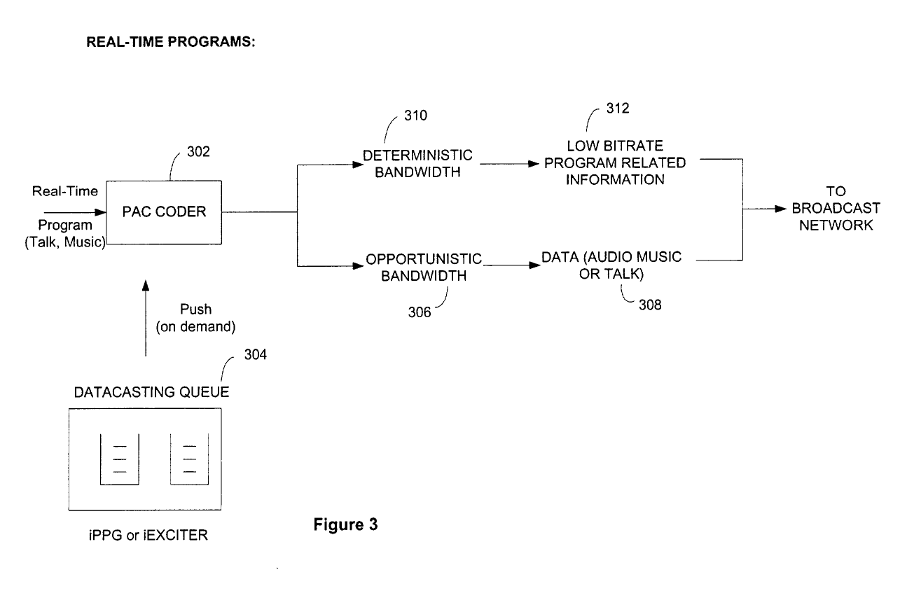

FIG. 3 illustrates the first instance, wherein the input data is associated with real-time programs, such as talk shows (similar to data shown in FIG. 2). In this instance, the iPPG 304 of the present invention pushes data from a pre-managed datacasting service queue 304. The datacasting service queue 304 is resident in either a push-pull gateway (PPG), or at an exciter. It should be noted that although the preferred embodiment describes examples of specific locations of the datacasting queue, one skilled in the art can envision other locations, and hence should not use the location to limit the scope of the present invention.

The opportunistic bandwidth 306 is used in this instance for transmitting the non-real-time encoded data 308, and the deterministic bandwidth 310 is used for transmitting real-time program-related information 312. For example, if audio content associated with a talk show is being encoded, then information related to the talk show is transmitted in the deterministic bandwidth 310.

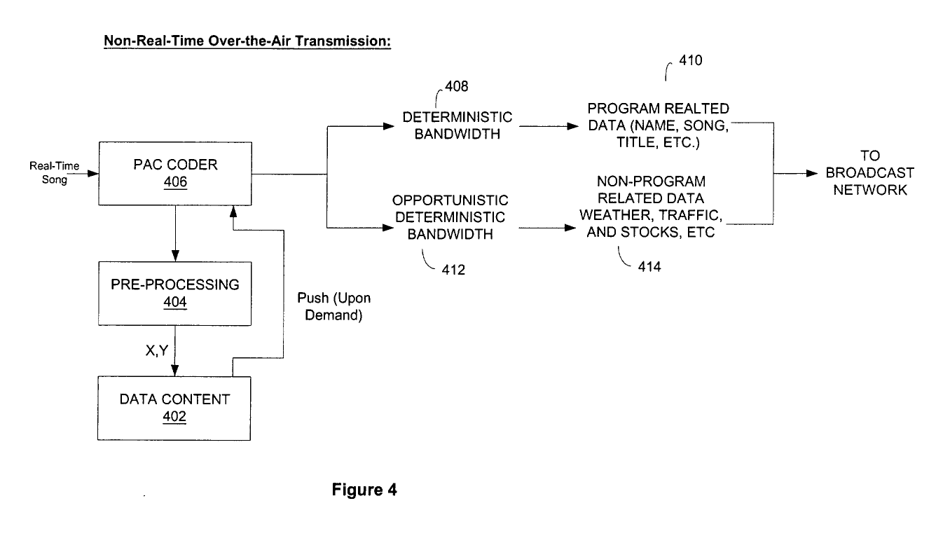

FIG. 4 illustrates the instance where content (music) is encoded and pre-processed to determine the opportunistic bandwidth amount, as well as its delay variance spread. This information is stored by a pre-processor 404. When a real-time transmission of the encoded song is placed over-the-air, the iPPG is aware of the availability of the opportunistic/deterministic bandwidth amount and its occurrence. This information is extremely useful to the iPPG because it can manage its queue contents. For example, a slow classic song can be pre-processed. The iPPG is then informed that X kbps is available with a known average delay spread of Y seconds. The iPPG will make use of X and Y dimension and may rearrange the contents destined for deterministic/opportunistic bandwidth 412, such as non-program-related data (such as weather, traffic, stocks, etc. 414). Data content 402 can also be pushed upon demand to the PAC coder 406. Additionally, the deterministic bandwidth 408 can be used for transmission of the encoded program-related data content 410 such as artist name, title, etc.

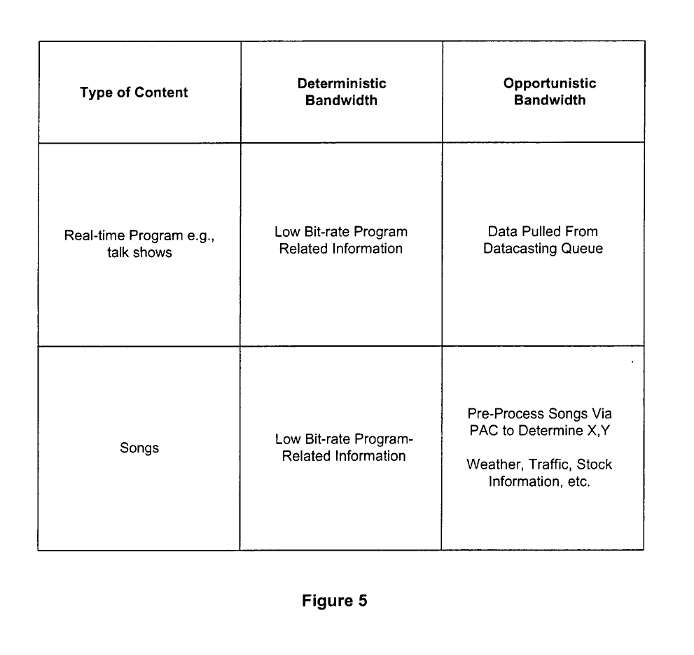

It should be noted that although the preferred embodiment describes the broadcasting of encoded data over an in-band on-channel (IBOC) network, one skilled in the art can envision using the PAC coder in conjunction with a push-pull gateway to broadcast over similar or equivalent networks. The table shown in FIG. 5 summarizes how transmission of various types of audio content may occur in the deterministic and opportunistic bandwidths.

The present invention includes a computer program code based product, which is a storage medium having program code stored therein, which can be used to instruct a computer to perform any of the methods associated with the present invention. The computer storage medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory, or data storage devices.

Implemented in computer program code based products are software modules for: receiving digital audio data associated with songs and real-time programs, wherein the digital audio data is intended for broadcast over a broadcast network; identifying an opportunistic and a deterministic bandwidth associated with said received digital audio content; encoding said received digital audio content; and in case of audio content associated with said real-time programs, utilizing said identified opportunistic bandwidth for transmitting said encoded digital audio content and utilizing said identified deterministic bandwidth for transmitting low bit-rate information related to said programs; or in case of audio content associated with said songs, utilizing said identified opportunistic bandwidth for transmitting non-real-time services and utilizing said identified deterministic bandwidth for transmitting said encoded digital audio content.

A system and method has been shown in the above embodiments for the effective implementation of dynamically allocating bandwidth in a digital audio broadcast. The above enhancements and described functional elements may be implemented in various computing environments. For example, the present invention may be implemented on a multi-nodal system (e.g., LAN) or networking system (e.g. Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of broadcast communications and digital signal processing.

While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by type of content to be broadcast, type of program related information, type of non-real-time services, location of the perceptual audio coder, software/program, computing environment, or specific computing hardware.

1. A method for intelligent usage of encoder unused bandwidth in a digital audio broadcast, said method comprising the steps of:
a. receiving digital audio data associated with either first multimedia content or second multimedia content, said digital audio data intended for broadcast over a broadcast network;
b. identifying available bandwidth and associated parameters related to said received digital audio data, said bandwidth comprising both opportunistic and deterministic components;
c. encoding said received digital audio data; and
d. if said received digital audio data is associated with said first multimedia content, utilizing said identified opportunistic bandwidth for transmitting non-real-time services and utilizing said identified deterministic bandwidth for transmitting real-time services, or
e. if said received digital audio data is associated with said second multimedia content, utilizing said identified opportunistic bandwidth for transmitting said encoded digital audio data and utilizing said identified deterministic bandwidth for transmitting low bit-rate information related to said second multimedia content.

2. A method for intelligent usage of encoder unused bandwidth in a digital audio broadcast, as per claim 1, wherein said first multimedia content is program related content associated with said real-time services, and said second multimedia content is data content associated with non-real-time programs.

3. A method for intelligent usage of encoder unused bandwidth in a digital audio broadcast, as per claim 1, wherein said non-real-time services is any of, or a combination of, the following: weather, traffic, and stocks.

4. A method for intelligent usage of encoder unused bandwidth in a digital audio broadcast, as per claim 1, wherein said encoding is performed via a perceptual audio coder (PAC).

5. A method for intelligent usage of encoder unused bandwidth in a digital audio broadcast, as per claim 1, wherein said received digital audio data is pulled from a datacasting queue.

6. A method for intelligent usage of encoder unused bandwidth in a digital audio broadcast, as per claim 5, wherein said datacasting queue is resident in a push-pull gateway.

7. A method for intelligent usage of encoder unused bandwidth in a digital audio broadcast, as per claim 5, wherein said datacasting queue is resident in a digital audio receiver.

8. A method for intelligent usage of encoder unused bandwidth in a digital audio broadcast, as per claim 1, wherein said broadcast network is an in-band on-channel (IBOC) network.

9. An article of manufacture comprising a computer usable medium having computer program code embodied therein for intelligent usage of encoder unused bandwidth in a digital audio broadcast, said medium comprising:
a. computer readable program code receiving digital audio data associated with either first multimedia content or second multimedia content, said digital audio data intended for broadcast over a broadcast network;
b. computer readable program code identifying available bandwidth and associated parameters related to said received digital audio data, said bandwidth comprising both opportunistic and deterministic components;
c. computer readable program code encoding said received digital audio data; and
d. if said received digital audio data is associated with said first multimedia content, computer readable program code utilizing said identified opportunistic bandwidth for transmitting non-real-time services and computer readable program code utilizing said identified deterministic bandwidth for transmitting said real-time services, or
e. if said received digital audio data is associated with said second multimedia content, computer readable program code utilizing said identified opportunistic bandwidth for transmitting said encoded digital audio data and computer readable program code utilizing said identified deterministic bandwidth for transmitting low bit-rate information related to said second multimedia content.

10. An article of manufacture comprising a computer usable medium having computer program code embodied therein for intelligent usage of encoder unused bandwidth in a digital audio broadcast, as per claim 9, wherein said computer readable program code for encoding implements a perceptual audio coder (PAC).

11. A system for intelligent usage of encoder unused bandwidth in a digital audio broadcast, said system comprising:
a. a digital audio data receiver receiving digital audio data broadcast over a network, said digital audio data associated with either first multimedia content or second multimedia;
b. a bandwidth identifier identifying available bandwidth and associated parameters related to said received digital audio data, said bandwidth comprising both opportunistic and deterministic components;
c. an encoder encoding said received digital audio data; and
d. a transmitter,
when receiving audio data associated with said first multimedia content, transmitting non-real-time services via said identified opportunistic bandwidth, and transmitting real-time services via said identified deterministic bandwidth, or
when receiving digital audio data associated with said second multimedia content, transmitting said encoded digital audio data via said identified opportunistic bandwidth, and transmitting low bit-rate information related to said programs via identified deterministic bandwidth.

12. A system for intelligent usage of encoder unused bandwidth in a digital audio broadcast, as per claim 11, wherein said first multimedia content is program related content associated with said real-time services, and said second multimedia content is data content associated with non-real-time programs.

13. A system for intelligent usage of encoder unused bandwidth in a digital audio broadcast, as per claim 11, wherein said non-real-time services is any of, or a combination of, the following: weather, traffic, and stocks.

14. A system for intelligent usage of encoder unused bandwidth in a digital audio broadcast, as per claim 11, wherein said encoder is a perceptual audio coder (PAC).

15. A system for intelligent usage of encoder unused bandwidth in a digital audio broadcast, as per claim 11, wherein said received digital audio data is pulled from a datacasting queue.

16. A system for intelligent usage of encoder unused bandwidth in a digital audio broadcast, as per claim 15, wherein said datacasting queue is resident in a push-pull gateway.

17. A system for intelligent usage of encoder. unused bandwidth in a digital audio broadcast, as per claim 15, wherein said datacasting queue is resident in a receiver.

18. A system for intelligent usage of encoder unused bandwidth in a digital audio broadcast, as per claim 11, wherein said network is an in-band on-channel (IBOC) network.
